(19) United States
(12) Patent Application Publication
(10) Pub. No.: US 2009/0125196 A1
(43) Pub. Date: May 14, 2009

(54) APPARATUS AND METHOD FOR MONITORING THE STABILITY OF A CONSTRUCTION MACHINE

(75) Inventors: Felix E. Velazquez, Valrico, FL (US); Michael D. Dwyer, Seminole, FL (US); John W. Thornberry, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/939,961

(22) Filed: Nov. 14, 2007

(51) Int. Cl. G06F 19/00; G01C 19/38; G08B 21/00

(52) U.S. Cl. 701/50; 37/413; 74/5 R

(57) ABSTRACT

Systems and methods for monitoring the stability of a construction machine are provided. A gyroscope is configured to detect an angle of inclination of the construction machine relative to a vertical axis and generate an inclination signal representative thereof. A processor in operable communication with the gyroscope is configured to receive the inclination angle and generate a warning signal when the angle of inclination exceeds a predetermined threshold. An alarm device in operable communication with the processor is configured to generate an alarm to indicate to a user of the construction machine when the angle of inclination has exceeded the predetermined threshold.

### TECHNICAL FIELD

The present invention generally relates to construction machines, such as cranes, and more particularly relates to an apparatus and method for monitoring the stability of a construction machine.

### BACKGROUND

Modern construction machines, such as cranes, backhoes, and excavators, often depend on the skill and experience of the operator to maintain stability. Typically, the machinery itself does not include any built-in system to determine if a particular load will allow the machine to maintain its stability while the load is being lifted or when the load is moved from one side of the machine to the other (e.g., from in front of the machine to a side of the machine). Often, an experienced operator will lift a potential load several inches off the ground to see if the construction machine experiences any inclination or tilting. If such an operator does feel an excessive amount of movement, he or she will often reduce the size of the potential load to that which the machine is capable of safely lifting.

Accordingly, it is desirable to provide a method and system for monitoring the stability of a construction machine to alert operators when the machine is becoming unstable. Furthermore, other desirable features and characteristics of the present invention will become apparent from the subsequent detailed description of the invention and the appended claims, taken in conjunction with the accompanying drawings and this background of the invention.

### BRIEF SUMMARY

A stability monitoring system for a construction machine is provided. The stability monitoring system includes a gyroscope configured to detect an angle of inclination of the construction machine relative to a vertical axis and generate an inclination signal representative thereof, a processor in operable communication with the gyroscope and configured to receive the inclination angle and generate a warning signal when the angle of inclination exceeds a predetermined threshold, and an alarm device in operable communication with the processor and configured to generate an alarm to indicate to a user of the construction machine when the angle of inclination has exceeded the predetermined threshold.

A construction machine is provided. The construction machine includes a frame, a gyroscope coupled to the frame, the gyroscope being configured to detect an angle of inclination of the frame relative to substantially vertical axis and generate an inclination signal representative thereof, and a processor coupled to the frame and in operable communication with the gyroscope, the processor being configured to receive the inclination angle and generate a warning signal when the angle of inclination exceeds a predetermined threshold.

A method of operating a construction machine is provided. An angle of inclination of a frame of the construction machine is detected. An inclination signal representative of the angle of inclination is generated. A warning signal based on the inclination signal is generated when the angle of inclination exceeds a predetermined threshold.

### BRIEF DESCRIPTION OF THE DRAWINGS

The present invention will hereinafter be described in conjunction with the following drawing figures, wherein like numerals denote like elements, and

FIG. 1 is a block diagram of a construction machine according to one embodiment of the present invention;

FIG. 2 is a side view of the construction machine of FIG. 1;

FIG. 3 is a block diagram of a stability monitor within the construction machine of FIG. 1;

FIG. 4 is a plan view of a gyroscope within the stability monitor of FIG. 3;

FIG. 5 is a schematic plan view of the construction machine of FIG. 2;

FIG. 6 is a side view of the construction machine of FIG. 2 after a turret thereof has been rotated;

FIG. 7 is a schematic plan view of the construction machine of FIG. 6; and

FIG. 8 is a side view of the construction machine of FIG. 6 placed on a sloped terrain.

### DETAILED DESCRIPTION

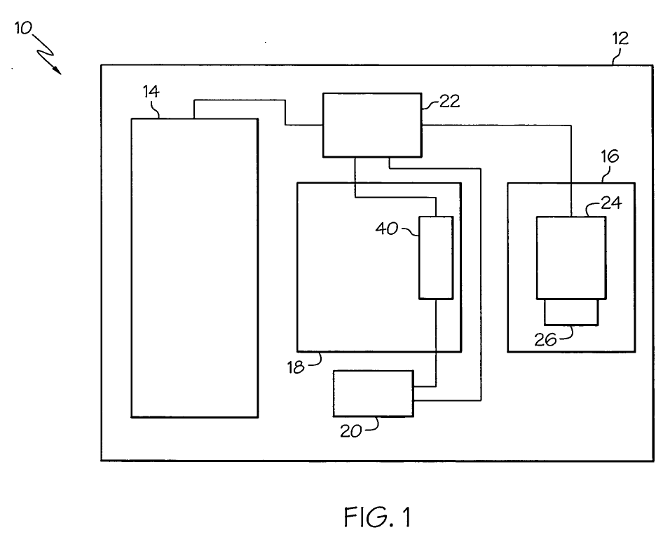

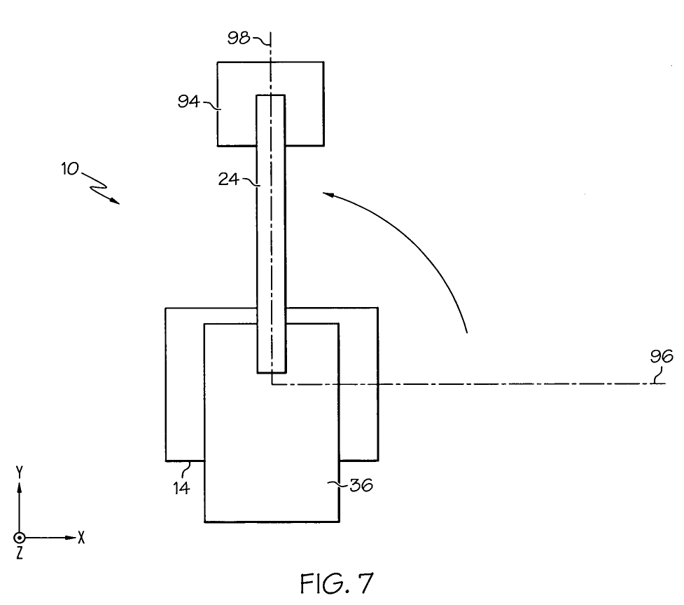

The following detailed description is merely exemplary in nature and is not intended to limit the invention or the application and uses of the invention. Furthermore, there is no intention to be bound by any expressed or implied theory presented in the preceding technical field, background, and brief summary or the following detailed description. It should be appreciated that the particular implementations shown and described herein are illustrative of the invention and its best mode and are not intended to otherwise limit the scope of the invention in any way. It should also be understood that FIGS. 1-8 are merely illustrative and may not be drawn to scale. Further, in several of the drawings, a Cartesian coordinate system, including x, y, and z axes and/or directions, is shown to clarify the relative orientation of the components, according to the various embodiments. However, this coordinate system is only intended to assist in the explanation of various aspects of the present invention, and should be not construed as limiting.

FIG. 1 to FIG. 8 illustrate a system and a method for monitoring the stability of a construction machine, such as a crane. A gyroscope is provided and configured to detect an angle of inclination of a frame of the construction machine relative to a substantially vertical axis. A processor in operable communication with the gyroscope is configured to receive a signal from the gyroscope and generate a warning signal when the angle of inclination exceeds a predetermined threshold. An alarm device in operable communication with the processor is configured to generate an alarm to indicate to a user of the construction machine when the angle of inclination has exceeded the predetermined threshold. The alarm may be a visual alarm, an audible alarm, or an interruption of the operability of a lifting mechanism on the construction machine.

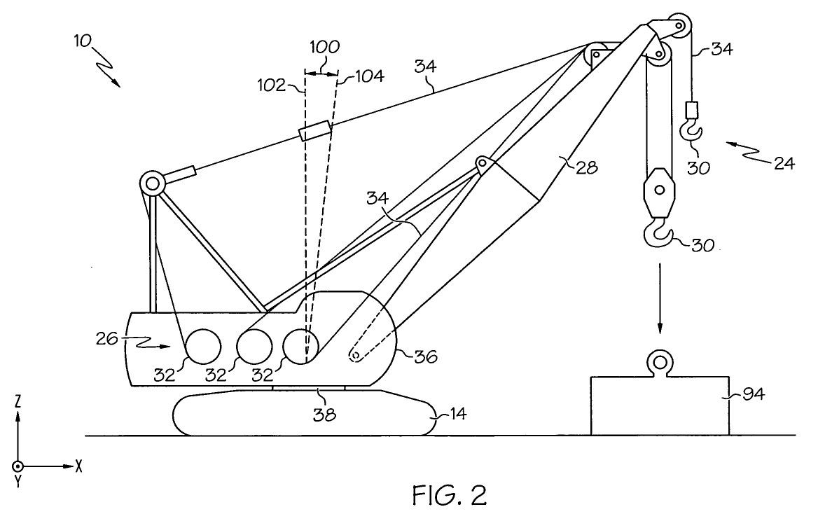

FIG. 1 is a block diagram illustrating a construction machine 10 according to one embodiment of the present invention, while FIG. 2 is a side view of the construction machine 10 shown in greater detail. The construction machine 10 is a mobile crane and includes a frame 12, a locomotion system 14, a lifting system 16, a cab 18, a stability monitoring system 20, and an electronic control system 22. In the depicted embodiment, the locomotion system 14 includes a series of caterpillar tracks, as commonly understood, coupled to the frame 12 near a lower portion thereof. The lifting system 16 includes a lifting mechanism 24 and an actuation system 26. Referring specifically to FIG. 2, the lifting mechanism 24 includes a boom 28 with multiple hooks 30, and the actuation system 26 includes multiple winches 32 coupled to the boom 28 and the hooks 30 through cables 34 to raise and lower the boom 28 and the hooks 34. Still referring to FIG. 2, the boom 28 and the winches 32 are connected to an upper portion, or turret, 36 that is coupled to the locomotion system 14 through a rotation bearing 38 and houses the cab 18. Although not shown in detail, the cab 18 is a compartment suitable for occupation by a user to control the operation of the construction machine 10 using various user input mechanisms (not shown) and includes an indicator panel 40 (FIG. 1) that is described in greater detail below and may be considered a part of the stability monitoring system 20.

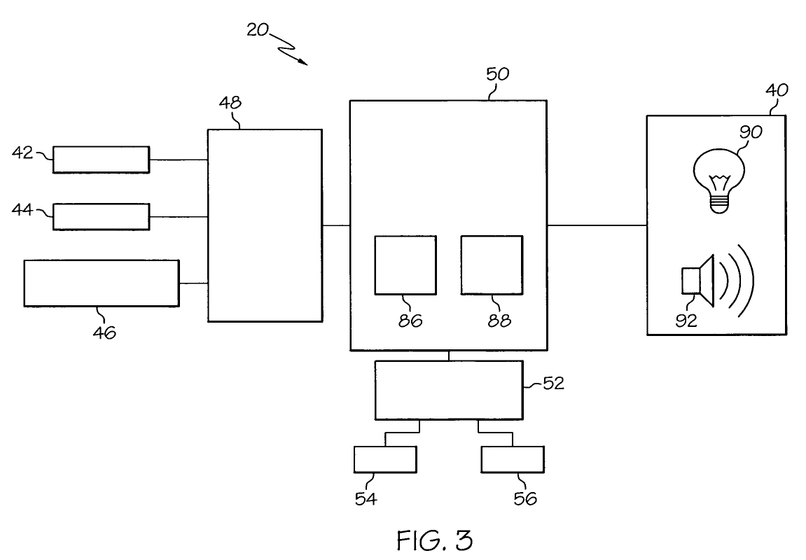

FIG. 3 illustrates the stability monitoring system 20 in greater detail. The system 20 includes first and second gyroscopes 42 and 44, a gravity sensor 46, sensor electronics 48, a microcontroller (or computing) system 50, a power supply 52, a battery 54, a main power interface 56, and the indicator panel 40. Each of the gyroscopes 42 and 44 is configured to detect inclination or tilting (or rotation), of the construction machine 10 in substantially perpendicular directions. More specifically, referring to FIGS. 2 and 3, the first gyroscope 42 is configured to detect inclination of the construction machine 10 in a direction along the x-axis shown in FIG. 2 (i.e., about the y-axis or in a plane defined by the x-axis and the z-axis). The second gyroscope 44 is configured to detect inclination of the construction machine 10 in a direction along the y-axis shown in FIG. 2 (i.e., about the x-axis or in a plane defined by the y-axis and the z-axis).

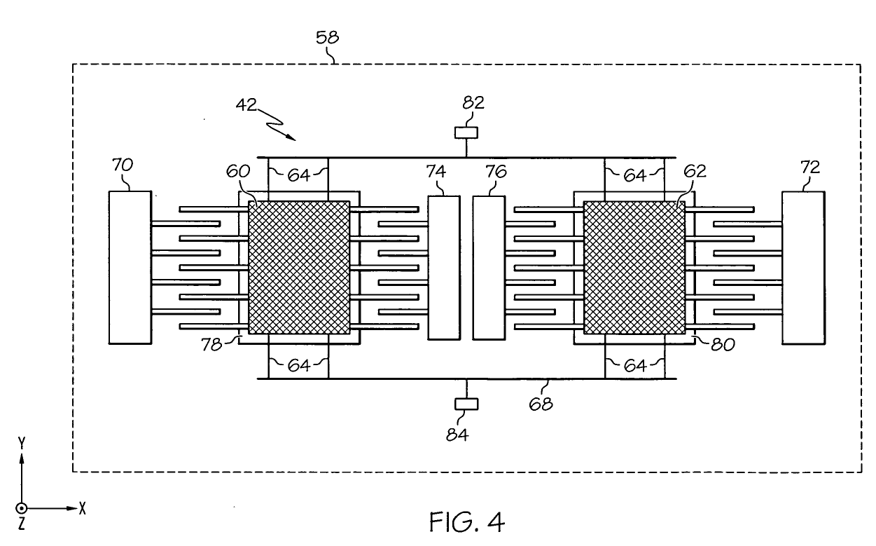

FIG. 4 illustrates the first gyroscope 42 in greater detail. In one embodiment, the first gyroscope 42 (and/or the second gyroscope 44) is a microelectromechanical system (MEMS) gyroscope. While FIG. 4 shows the MEMS gyroscope 42 as a tuning fork gyroscope, other MEMS vibratory gyroscopes that use a Coriolis acceleration to detect rotation, such as an angular rate sensing gyroscope, may also be used. The MEMS gyroscope 42 may be formed on a substrate 58 and may include proof masses 60 and 62, a plurality of (e.g., eight) support beams 64, cross beams 66 and 68, motor drive combs 70 and 72, motor pickoff combs 74 and 76, sense plates 78 and 80, and anchors 82 and 84.

The proof masses 60 and 62 may be any mass suitable for use in a MEMS gyroscope system. In a preferred embodiment, the proof masses 60 and 62 are silicon plates. Other materials that are compatible with micromachining techniques may also be employed. Although FIG. 4 shows two proof masses, other numbers of proof masses may be used. The proof masses 60 and 62 are located substantially between the motor drive combs 70 and 72 and the motor pickoff combs 74 and 76, respectively. The proof masses 60 and 62 include a plurality (e.g., ten) of comb-like electrodes extending towards the motor drive combs 70 and 72 and the motor pickoff comb 74 and 76. In one embodiment, the proof masses 60 and 62 are supported above the sense plates 78 and 80 by the support beams 64.

The support beams 64 may be micromachined from a silicon wafer and may act as springs allowing the proof masses 60 and 62 to move within the drive plane (x-axis) and the sense plane (z-axis). The support beams 64 are connected to the cross beams 66 and 68. The cross beam 66 and 68 are connected to the anchors 82 and 84, which are in turn connected to the substrate 58, thus providing support for the MEMS gyroscope 42.

The motor drive combs 70 and 72 include a plurality of comb-like electrodes extending towards the proof masses 60 and 62. The number of the electrodes on the motor drive combs 70 and 72 may be determined by the number of electrodes on the proof masses 60 and 62.

The comb-like electrodes of the proof masses 60 and 62 and the motor drive combs 70 and 72 may jointly form capacitors. The motor drive combs 70 and 72 may be connected to drive electronics (not shown in FIG. 4) that cause the proof masses 60 and 62 to oscillate along the drive plane (x-axis) by using the capacitors formed by the electrodes.

The motor pickoff combs 74 and 76 include a plurality of comb-like electrodes extending towards the proof masses 60 and 62. The number of the electrodes on the motor pickoff combs 74 and 76 may be determined by the number of electrodes on the proof masses 60 and 62. The comb-like electrodes of the proof masses 60 and 62 and the motor pickoff combs 74 and 76 may jointly form capacitors that allow the MEMS gyroscope 42 to sense motion in the drive plane (x-axis).

The sense plates 78 and 80 may form parallel capacitors with the proof masses 60 and 62. If an angular rate input is applied to the MEMS gyroscope 42 about the y-axis while proof masses 60 and 62 are oscillating along the x-axis, a Coriolis force may be detected as a displacement or motion in the z-axis by the parallel capacitors. The output of the MEMS gyroscope 42 may be a signal proportional to the change in capacitance. The signal may be a current if a sense bias voltage is applied to the sense plates 78 and 80. The sense plates 78 and 80 may be connected to the sense electronics that detect the change in capacitance as the proof masses 60 and 62 move towards and/or away from the sense plate 78 and 80.

Referring again to FIG. 3, the second gyroscope 44 may be similar to the first gyroscope 42 but arranged to detect rotation about the x-axis. The gravity sensor 46 is a device capable of detecting when the construction machine 10 is in a substantially horizontal orientation (i.e., on level ground) by measuring the strength of the force of gravity in a direction relative to itself, as is commonly understood. The gravity sensor 46 may include a spring and mass setup, along with suitable electronics, arranged such that when the construction machine 10 is on level ground, the spring experiences a relative maximum force, as caused by the spring being in a substantially vertical orientation. The sensor electronics 48 is in operable communication with the sensors (i.e., the gyroscopes 42 and 44 and the gravity sensor 46) and the microcontroller 50 and includes circuitry suitable for receiving the electrical signals from the sensors and serving as an interface between the sensors and the microcontroller 50.

The microcontroller 50 may include any one of numerous known general-purpose microprocessors 86 (or an application specific processor) that operates in response to program instructions and a memory 88. The memory 88 may include random access memory (RAM) and/or read-only memory (ROM) that has instructions stored thereon (or on another computer-readable medium) for carrying out the processes and methods described below. It should be appreciated that the microcontroller 50 may be implemented using various other circuits besides a programmable processor. For example, digital logic circuits and analog signal processing circuits may also be used. The microcontroller 50 is in operable communication with the sensor electronics 48, the power supply 52, and the indicator panel 40.

As previously mentioned, the indicator panel 40 is installed within the cab 18 and includes a visible alarm device 90 and a audible alarm device 92. In one embodiment, the visible alarm device 90 is a light clearly visible by the operator of the construction machine, and the audible alarm device 92 is a speaker. The power supply 52 provides power to the other components shown in FIG. 3 from the battery 54 and/or the main power interface 56 which is coupled to the main power bus of the construction machine 10.

Referring again to FIG. 1, the electronic control system 22 is in operable communication with the locomotion system 14, the lifting system 16, and the stability monitoring system 20, as well as the user input devices within the cab 18 (not shown). Similar to the microcontroller 50 shown in FIG. 2, the electronic control system 22 may include one or more processor and memories having instructions stored thereon for operating the construction machine 10 as described below.

During operation, referring to FIGS. 2, 5, and 6, the construction machine 10 is transported using the locomotion system 14. In one mode of operation, the construction machine moves with the lifting mechanism 24 aligned with a first longitudinal axis 96 that is parallel with the x-axis and perpendicular to a second longitudinal axis 98 (which is parallel with the y-axis). The boom 28 and/or the hooks 30 are lowered with the winches 32, and the hooks 30 are coupled to the object 94. The winches 32 are then used to raise the boom 28 and/or the hooks 30, along with the object 94.

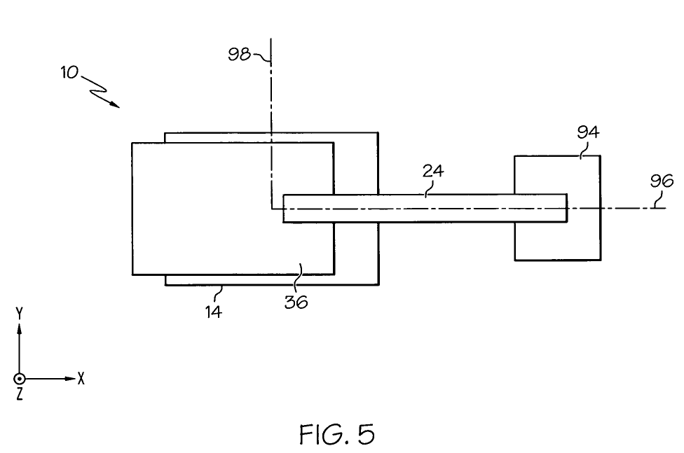

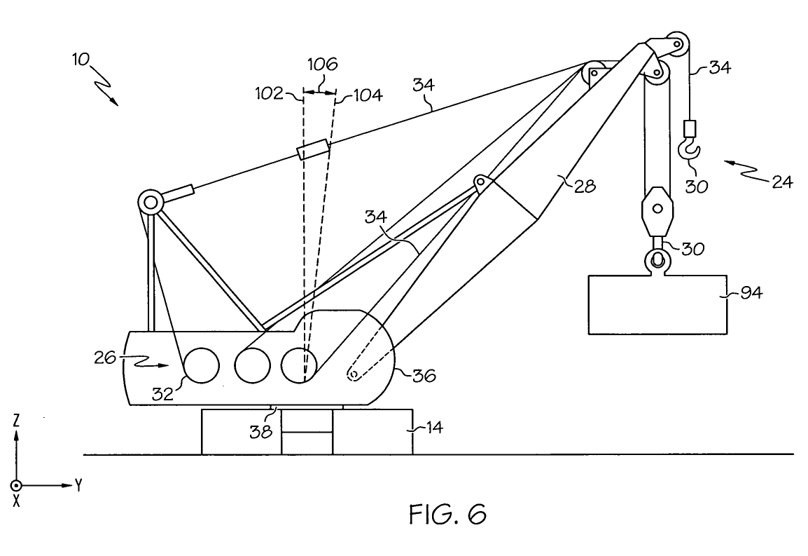

As the winches 32 are actuated to raise the object 94, the construction machine 10 often experiences some tilting or inclination from an angle of inclination 100 measured between a vertical axis 102 and a latitudinal axis 104 of the construction machine 10. The vertical axis 102 is parallel with the force of gravity, while the latitudinal axis 104 represents a direction that is perpendicular to the longitudinal axes 96 and 98 shown in FIGS. 5 and 6. That is, the latitudinal axis 104 is a “vertical” axis relative to the frame of the construction machine 10.

In one embodiment, the stability monitoring system 20 is used to monitor the angle of inclination 100 along both longitudinal axes 96 and 98 (and/or the x-axis and the y-axis). Referring to FIG. 5 in combination with FIG. 2, when the angle of inclination 100, along either of the longitudinal axes 96 and 98, exceeds a predetermined threshold, as determined by the first and second gyroscopes 42 and 44 and/or the microcontroller 50 (FIG. 3), an alarm or alert is generated to notify the user that the construction machine 10 is losing stability and nearing a critical angle of inclination at which point the construction machine may topple. In one embodiment, the alarm is generated at an angle of inclination that is approximately 20% less than the critical angle.

In one embodiment, the alarm is visible alarm generated by the visible alarm device 90 or a sound generated by the audible alarm device 92. In another embodiment, the alarm is a combination of visible and audible alarms generated by the devices 90 and 92. In yet another embodiment, the alarm is (or is accompanied by) a “cut-off” signal from microcontroller 50 that at least partially or temporarily disables the lifting system 16. The cut-off signal may only allow the lifting system 16 to be lowered (to re-stabilize the construction machine 10) and/or may completely disable the lifting system 16 for a pre-set amount of time to indicate to the user of the imminent problem.

Referring again to FIGS. 2, 5, 6, and 7, the predetermined angle of inclination at which the alarm is generated may be different along the first and second longitudinal axes 96 and 98. For instance, as one skilled in the art will appreciate, the construction machine 10 may be more stable along the first longitudinal axis 96 than along the second longitudinal axis 98 because the “footprint” (or width) of the locomotion system 14 is greater along the first longitudinal axis 96 than along the second longitudinal axis 98. Therefore, when the turret 36 is turned such that the lifting mechanism 24 is aligned with the second longitudinal axis 98, a second, smaller angle of inclination 106, as measured between the vertical axis 102 and the latitudinal axis 104 by the second gyroscope 44 (FIG. 3), may cause the alarm to be generated. That is, in one embodiment, due to the decreased stability along the second longitudinal axis 98, a decreased amount of tilting or rotation about the x-axis is required to trigger the alarm signal than the rotation about the y-axis that is required to trigger the alarm.

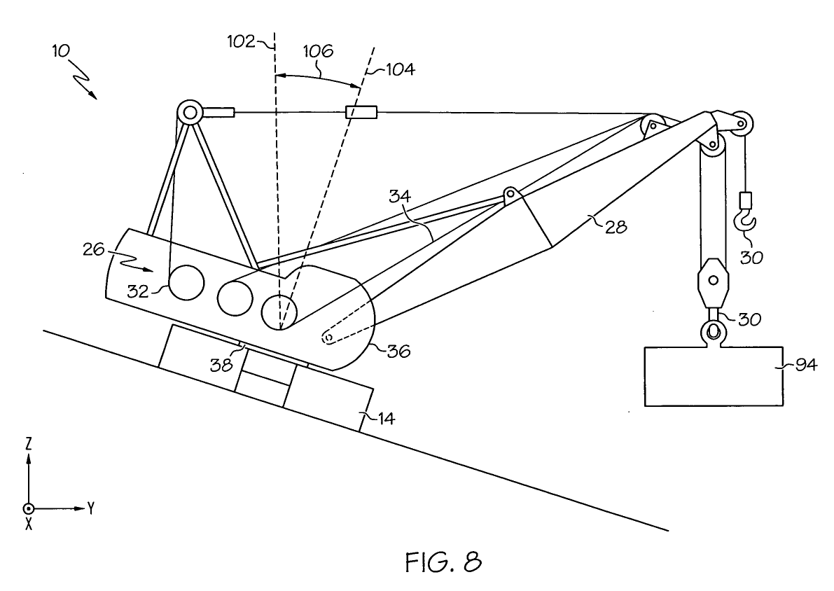

The operation described above may be supplemented with the use of the gravity sensor 46 within the stability monitoring system 20 shown in FIG. 3. The gravity sensor 46 may in effect adjust the orientation of the latitudinal axis 104 relative to the vertical axis 102 such that angles of inclination of adjusted when the construction machine 10 is on ground that is not flat or horizontal. As such, in the example shown in FIG. 8, simply placing the construction machine 10 on sufficiently sloped terrain may cause the angle on inclination 106 to exceed the predetermined threshold and cause the alarm to be generated. If the slope of the terrain is not sufficient to cause the alarm, additional inclination caused by lifting the object 94, which may be considerably less than the inclination depicted in FIG. 6, may cause the alarm, particularly if the object 94 is being held “downhill” of the construction machine 10. However, although not shown, if the object 94 is being held “uphill” of the construction machine, the stability monitor 20, along with the gravity sensor 46, may allow for considerably more inclination caused by the lifting of the object 94.

One advantage of the system described above is that the stability monitor provides a warning for construction machine operators when the construction machine begins to loss stability. Another advantage is that because, at least in one embodiment, MEMS gyrscopes are used to measure the inclination of the construction machine, manufacturing costs of the stability monitor are minimized while still providing accurate measurements. Further, because of the minimal involvement with the main electrical system of the construction machine the stability monitor may be installed into construction machines well after the construction machine is manufactured.

Other embodiments may utilize the stability monitor in construction machinery, both fixed and mobile, other than cranes, such as, for example, aerial work platforms, asphalt pavers, backhoes, boomtrucks, bulldozers, combat engineering vehicles (CEV), compact excavators, construction and mining trucks, cranes, cure rigs, dredgings, drilling machines, excavators, feller bunchers, forklifts, Fresno scrapers, front shovels, harvesters, hydromechanical work tools, knuckleboom loaders, motor graders, pile drivers, pipelayers, roadheaders, road rollers, rotary tillers, skid steer loaders, skidders, steam shovels stompers, street sweepers, telescopic handlers, tractors, trenchers, tunnel boring machines, underground mining equipment, Venturi-mixers, and yarders. Other rotation detection devices besides MEMS gyroscopes may be used, such as ring laser gyroscopes and interferometric fiber optic gyroscopes (IFOG).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A stability monitoring system for a construction machine comprising:
a gyroscope configured to detect an angle of inclination of the construction machine relative to a vertical axis and generate an inclination signal representative thereof;
a processor in operable communication with the gyroscope and configured to receive the inclination angle and generate a warning signal when the angle of inclination exceeds a predetermined threshold; and
an alarm device in operable communication with the processor and configured to generate an alarm to indicate to a user of the construction machine when the angle of inclination has exceeded the predetermined threshold.

2. The system of claim 1, wherein the angle of inclination is within a plane defined by the vertical axis and a horizontal axis.

3. The system of claim 2, further comprising a second gyroscope in operable communication with the processor, the second gyroscope being configured to detect a second angle of inclination of the construction machine relative to the vertical axis and generate a second inclination signal representative thereof, and wherein the processor is further configured to receive the second inclination signal and generate the warning signal when the second angle of inclination exceeds a second predetermined threshold.

4. The system of claim 3, wherein the second angle of inclination is within a second plane defined by the vertical axis and a second horizontal axis.

5. The system of claim 4, wherein the second horizontal axis is substantially perpendicular to the horizontal axis.

6. The system of claim 5, wherein the alarm device comprises at least one of a audio device and a video device.

7. The system of claim 6, wherein the processor is further configured to interrupt actuation of an actuator coupled to a lifting mechanism on the construction machine when the warning signal is generated.

8. A construction machine comprising:
a frame;
a gyroscope coupled to the frame, the gyroscope being configured to detect an angle of inclination of the frame relative to substantially vertical axis and generate an inclination signal representative thereof; and
a processor coupled to the frame and in operable communication with the gyroscope, the processor being configured to receive the inclination angle and generate a warning signal when the angle of inclination exceeds a predetermined threshold.

9. The construction machine of claim 8, further comprising alarm device coupled to the frame and in operable communication with the processor, the alarm device being configured to generate an alarm to indicate to a user when the angle of inclination has exceeded the predetermined threshold.

10. The construction machine of claim 9, wherein the angle of inclination is within a plane defined by the vertical axis and a horizontal axis.

11. The construction machine of claim 10, further comprising a second gyroscope coupled to the frame and in operable communication with the processor, the second gyroscope being configured to detect a second angle of inclination of the frame relative to the vertical axis and generate a second inclination signal representative thereof, and wherein the processor is further configured to receive the second inclination signal and generate the warning signal when the second angle of inclination exceeds a second predetermined threshold.

12. The construction machine of claim 11, wherein the second angle of inclination is within a second plane defined by the vertical axis and a second horizontal axis.

13. The construction machine of claim 12, wherein the second horizontal axis is substantially perpendicular to the horizontal axis.

14. The construction machine of claim 13, wherein the alarm is at least one of a audible alarm and a visible alarm.

15. The construction machine of claim 8, further comprising:
a lifting mechanism coupled to the frame;
an actuator coupled to the frame and the lifting mechanism, actuation of the actuator causing the lifting mechanism to move relative to the frame; and
a user input mechanism coupled to the frame and in operable communication with the actuator and the processor.

16. The construction machine of claim 15, wherein the warning signal causes interruption of actuation of the actuator.

17. A method of operating a construction machine comprising:
detecting an angle of inclination of a frame of the construction machine;
generating an inclination signal representative of the angle of inclination; and
generating a warning signal based on the inclination signal when the angle of inclination exceeds a predetermined threshold.

18. The method of claim 17, further comprising generating an alarm with an alarm device coupled to the frame to indicate to a user of the construction machine that the angle of inclination has exceeded the predetermined threshold.

19. The method of claim 18, wherein the said generation of the alarm comprises generating at least one of an audible alarm and a visible alarm with the alarm device.

20. The method of claim 19, further comprising interrupting movement of a lifting mechanism coupled to the frame of the construction machine based on the warning signal.
